(19) United States
(12) Patent Application Publication
(10) Pub. No.: US 2025/0025972 A1
(43) Pub. Date: Jan. 23, 2025

(54) Modular Frame for Multi-Axis Motion System

(71) Applicant: 3D Systems, Inc., Rock Hill, SC (US)

(72) Inventors: Alexander Gabriel Steinberg, Woodland Park, CO (US); James Brian Christian, Peyton, CO (US); Mason Ham, Colorado Springs, CO (US)

(21) Appl. No.: 18/776,803

(22) Filed: Jul. 18, 2024

Related U.S. Application Data
(60) Provisional application No. 63/514,713, filed on Jul. 20, 2023.
(60) Provisional application No. 63/663,403, filed on Jun. 24, 2024.

(51) Int. Cl. B23Q 15/007; B23Q 1/01

(52) U.S. Cl. CPC B23Q 15/0075; B23Q 1/015

(57) ABSTRACT

In the context of multi-axis motion control systems, a modular frame is disclosed comprising two or more subassemblies that each comprise one or more motion actuators. Each subassembly comprises a reference interface surface along which the subassembly may be attached to that of an adjoining subassembly. Motion actuators of a first subassembly are aligned to a first reference interface surface so that motion vectors of the actuators come into precise alignment with the motion vectors of actuators on a second subassembly when the first subassembly and second subassembly are joined. In forming an additive manufacturing system, a material depositing component may be attached to the first subassembly and tested as a unit with the first subassembly before the second subassembly is made or becomes attached to the first subassembly.

### CROSS REFERENCE TO RELATED APPLICATIONS

This non-provisional patent application claims priority to U.S. Provisional Application Ser. No. 63/514,713, Entitled “Modular Frame for Multi-Axis Motion System” by Alexander Gabriel Steinberg et al., filed on Jul. 20, 2023, incorporated herein by reference under the benefit of U.S.C. 119(e). This non-provisional patent application also claims priority to U.S. Provisional Application Ser. No. 63/663,403, Entitled “Modular Frame for Multi-Axis Motion System” by Alexander Gabriel Steinberg et al., filed on Jun. 24, 2024, incorporated herein by reference under the benefit of U.S.C. 119(e).

### TECHNICAL FIELD

The present invention relates to constructing motion control systems and, more particularly, to constructing rigid modular frame subassemblies to which motion actuators may be mounted in forming a motion control system.

### BACKGROUND

Many industrial manufacturing systems are robotic mechanisms that operate by automatically moving components in a controlled or programmed manner along multiple axes within a given three-dimensional space.

For example, in the field of additive manufacturing wherein materials are deposited at specific locations in a programmed sequence to form an object, a multi-axis controlled motion system is frequently built by assembling a rigid frame and then attaching belts, pulleys, motors, linear bearings or slides, pivots, precision screws and other components to enable controlled relative motion between a material depositing component (such as a polymer extrusion nozzle) and a build surface or a workpiece attached to the build surface.

Using motorized linear actuators or the like, the relative motion is usually driven by electrical signals issuing from a computerized motion controller that coordinates multiple actuators to precisely follow a followed a programmed toolpath. In the case of additive manufacturing, the programmed toolpaths that are provided to the motion controller will usually have been derived from a digital model of the shape of the object that is to be formed. Some additive manufacturing processes that are known to use programmed toolpaths include filament-fed or pellet-fed polymer extrusion and directed energy deposition (DED).

The fidelity with which an additive manufacturing (AM) system forms an object according to a digital data model of the intended final shape of the object is highly dependent on the achieving a rigid frame, minimizing play in mechanical coupling or joints and establishing a known fixed orientation among linear or rotary motion axes, depending on machine geometry. Inaccurate orientations result in distorted parts being built by the AM system that deviate from the intended shape of the part as specified by a digital model.

Many implementations of motion systems for additive manufacturing systems arrange for motors to precisely control motion along three orthogonal axes, such that each motor and set of associated bearings, slides, belts and pulleys is intended to cause relative motion strictly in one axis without introducing a motion component along the other two axes. Ideally, this orthogonality holds true over the whole range of motion within the build environment.

The size of additive manufacturing systems range from small kits that are assembled by an end user, to pre-assembled desktop or freestanding machines that are assembled by a manufacturer, to large format printers having frames that are factory assembled with high precision as assured by measuring equipment, fixturing and machining of critical surfaces.

Small scale additive manufacturing systems are often built from rigid struts and use various fasteners and brackets to firmly attach the struts to one another. Variation in parts and fit does not assure a rigid frame with linear guides or bearings, and mounting surfaces for moving parts are not guaranteed to be orthogonal (or at other designed angles), especially in rectilinear structures that lack cross-bracing. Angular play and misalignment are common but acceptable for hobbyist-built units that are often aligned by ‘eyeball’ or using crude handheld squares. Such minimal structures can also deflect from an orthogonal condition if the machine is placed on an uneven surface or if the machine is impacted or jarred during transport.

Another form of construction is a hollow box or shell comprising flat panels joined along their edges, wherein the center of several of the flat panels are open, forming rectangular rings. Shafts, pulleys, bushings and the like are mounted inside the box or cage-like structure. This form of construction is suited for kits and favorable for use around novice or young users because the moving parts tend to be shielded by the edges of the box frame. This style of frame design assures a more-or-less fixed and repeatable alignment, though the alignment may not be accurate. Any misalignment is difficult to correct, particularly as to isolating adjustments to a single degree of freedom without impacting others. Any state of alignment achieved must be reassessed if the unit is partially disassembled for repairs or upgrades.

Makers of middle- to large-scale industrial AM systems may have far more advanced resources for achieving alignment and for establishing and maintaining precisely known relative orientations among different motion axes. These precise relationships are set among all the components at the time of manufacture and hopefully do not change over time, temperature or due to mishaps during shipment. Unfortunately, when some components of a large system are to be repaired, replaced or upgraded after deployment, the precise alignment resources available in the factory may not be available in the field. Furthermore, the fact that all the components of a large-scale system are aligned in concert with one another at the time of manufacture also means that all of the components of a large-scale system must come together in the factory at the same time before alignment can begin.

Regardless of size, any of the above AM systems may suffer from imperfections such as skewed bearing alignments, uneven component lengths and non-rectilinear joints. Even where some types of manufacture initially address these issues in the factory, this may not benefit a later field replacement or upgrade.

In the case of large machines (having a build volume of several cubic meters), depositing components such as pellet-fed extruders may have considerable mass and experience off-axis forces applied by supply lines and cables. The rigidity of the frame is crucial to handling the carriage load and maintaining precise positioning despite considerable acceleration and deceleration forces in any combination along multiple axes. Creating a heavy-duty motion system to maintain positional integrity while also allowing for precise adjustment of alignment during assembly poses a challenge.

### SUMMARY

The present teachings provide for a modular frame assembly upon which motion control actuators may be attached to form a multiple-axis motion control system. More specifically, the present teachings describe the construction of two or more subassemblies that each bear motion control actuators and may be separately assembled and aligned as to the action vectors of the actuators. The total set of actuators to implement all of the motions needed in the motion control system are partitioned among the two or more subassemblies. Each subassembly comprises a reference interface surface to which all of the actuators attached thereon are aligned. For assembly of a complete motion control system using two subassemblies, a first subassembly and second subassembly are mated along their respective reference interface surfaces which, in accordance with principles taught herein, assures that the motion vectors for actuators on the first subassembly are brought into a precise orientation with respect to motion vectors for actuators mounted on the second subassembly.

In accordance with some embodiments wherein a complete motion control system requires three axes of motion, a first subassembly may implement two axes of motion that are orthogonal to one another and parallel to a first reference interface surface of the first subassembly. A second subassembly, having a second reference interface surface designed to contact the first reference interface surface of the first subassembly, comprises one or more actuators that implement the third axis of motion. The actuators on the second subassembly are aligned to have a motion vector that is precisely perpendicular to the second reference interface surface. Based on the operating principles set forth herein, upon bringing the first reference interface surface into full contact with the second interface surface, the two motion vectors implemented by the actuators on the first subassembly are precisely orthogonal to the third motion vector implemented by one or more actuators on the second assembly.

In accordance with at least one preferred embodiment of the three-axis motion control system just described, the second subassembly comprises two linear actuators that work in tandem to implement the third motion axes and, in forming a framework of the second subassembly, these actuators are mounted to a single solid plate that is a component of the framework. In a preferred embodiment, the plate comprises a concave cutout portion to form a yoke that partially encircles a build chamber of the motion control system and places the mounted linear actuators on either side of the build chamber. In this embodiment, mounting both actuators on a single common plate maintains a parallel relationship between the motion vectors of the actuators even as the plate undergoes alignment with, and attachment to, other frame components, including those that provide for the second reference interface surface.

In accordance with at least one other embodiment, the second subassembly comprises interior-facing vertically oriented plates that are supported exteriorly by a surrounding grid of formed interlocking structures and the linear actuators for the third motion axis are mounted on inward-facing surfaces of the interior-facing plates. This places the motion actuators in close proximity to the supported load, the build plate to which they are coupled, and allows some of the exterior supporting grid members to be horizontally disposed and to encircle the interior-facing plates.

### BRIEF DESCRIPTION OF THE DRAWINGS

Various exemplary embodiments are illustrated by way of example, and not by way of limitation, in the following detailed description, claims and accompanying drawings, in which like reference numerals refer to similar elements and in which:

FIG. 1 is a pictorial depicting an additive manufacturing system that comprises a three-axis motion control system for moving an extruder within a build chamber in accordance with an example embodiment;

FIG. 2 is an exploded sketch of a multi-axis motion control system showing a manner of separation between two subassemblies in accordance with an example embodiment;

FIG. 3 is a pictorial of an upper subassembly implementing two axes of motion in accordance with an example embodiment;

FIG. 4 is an exploded sketch showing how multiple flat components with slots may be brought together in forming a frame for a lower subassembly in accordance with an example embodiment;

FIG. 5 is an exploded sketch showing the addition of top and front panels in further assembly of a frame for a lower subassembly in accordance with an example embodiment;

FIG. 6 is a pictorial representing the result of assembling components as shown in FIG. 4 and FIG. 5;

FIG. 7 is a pictorial of a lower subassembly having additional frame components, actuators and build surface added in accordance with an example embodiment;

FIG. 8A is a cutaway view of a portion of a lower subassembly where a yoke for mounting actuators becomes aligned to another member that forms a reference interface surface in accordance with an example embodiment;

FIG. 8B is a diagram of an alignment clamping device applied between components in accordance with an example embodiment;

FIGS. 9A-9D are conceptual block diagrams describing various process models for assembling, aligning and testing complete additive manufacturing systems in response to received orders, with FIGS. 9C and 9D representing process models implementing preferred embodiments of the present teachings;

FIG. 10 is a pictorial of a partially assembled additive manufacturing system featuring an alternative lower assembly in accordance with an example embodiment;

FIGS. 11A-11D show stages in assembling an alternative lower assembly in accordance with an example embodiment; and

FIG. 12 portrays detailed features formed in components of an alternative lower assembly in accordance with an example embodiment.

### DESCRIPTION

The present invention relates to a modular frame assembly that may be applied to constructing multi-axis motion systems, such as additive manufacturing systems, of various forms including those which bear heavy components and which may also provide for machining or ‘subtractive’ processes that particularly require both rigidity and precise positioning. The result is a highly manufacturable frame that benefits the management of inventories and delivery lead times as well as field replacements and upgrades after a system is deployed.

In accordance with example embodiments, a motion system frame is formed in at least two subassemblies that join along a reference interface surface to which each subassembly is independently aligned and normalized.

In an exemplary arrangement, an upper subassembly comprises a two-axis motion system mounted to a yoke that has been cut from a metal plate of substantial thickness, such as 10 mm. The cutting process is preferably by laser or by abrasive jet to minimize thermal warping of the plate. The plate forms the underside of the upper subassembly and presents a very flat surface. The motors and other components mounted to the top of the plate cause motion that is precisely parallel to the plane of the plate and are easily aligned to achieve an orthogonal relationship between the two axes. The upper subassembly may utilize various mechanisms to achieve two axis motion. One possible mechanism involves a transverse gantry comprising an X-axis motor with both ends of the gantry being supported and driven along an orthogonal direction by a pair of synchronized Y-axis motors. In fact, the use of a stable, self-contained upper subassembly having motion actuators mounted on a solid yoke plate enables the interchangeability of upper subassemblies (even switching to one having a different movement mechanism, such as a Core XY configuration) while assuring orthogonality with a third motion axis to be implemented by a lower subassembly. An attribute of various embodiments described herein is that, when exchanging upper subassemblies for repair, upgrade or other purposes, there is no need to loosen any attachments that are responsible for alignment. All aligned actuating components stay in place so that changeout of a subassembly does not jeopardize frame alignment that has already been established.

A lower subassembly comprises a rigid frame and houses the machinery for a third motion axis. Importantly, the lower subassembly features a flat upper plate configured to fit against the aforementioned yoke of the upper subassembly. In a preferred implementation, the lower subassembly comprises a U-shaped yoke formed by cutting a bulky flat plate and placing it in a vertical orientation to serve as a mounting surface for a pair of Z-axis drive units that straddle the build space. Using a single unified plate for the pair of Z-axis actuators assures that their action vectors remain parallel and resistant to being skewed during alignment and throughout the life of the machine. The U-shaped Z-axis yoke is preferably moved to a positioned to be exactly orthogonal to the upper plate before being welded into final position where it serves to support the upper plate.

In a reduction to practice, the first two axes have been implemented by the upper subassembly, referred to herein as the ‘X axis’ and the ‘Y axis’, to result in horizontal motion of a tool-bearing payload whereas the lower subassembly implements a strictly vertical motion of a build plate along what will be termed a ‘Z axis.’

When mated, the upper and lower subassemblies assure mutually orthogonal alignment among the three combined axes of motion, even though the upper and lower subassemblies will have been assembled and aligned as separate units.

As one practical advantage, the upper and lower subassemblies may be interchanged without requiring a collective ‘overall assembly’ alignment step as is characteristically needed (and often neglected) in other constructions. Another advantage for a manufacturer is the ability to separately assemble, align, test and calibrate an upper subassembly (including extruder or spindle payloads) independently of a lower subassembly. A manufacturer may decouple the production of upper and lower subassemblies and run separate production lines to independently balance production throughputs and inventories. These advantages stem from being able to build and align the respective subassemblies without requiring a complete frame to be assembled before axis alignment and extruder characterization can even begin. The modularity introduced by the present teachings provides advantages in manufacturability of, for example, mid-sized heavy duty AM machines with extruders or spindles as the tool end.

Alignment for orthogonality is separately built into the upper and lower subassemblies, early and in parallel, so that when the sections are combined along their respective reference interface surfaces to form a finished machine, no additional time is required to achieve a precisely aligned machine.

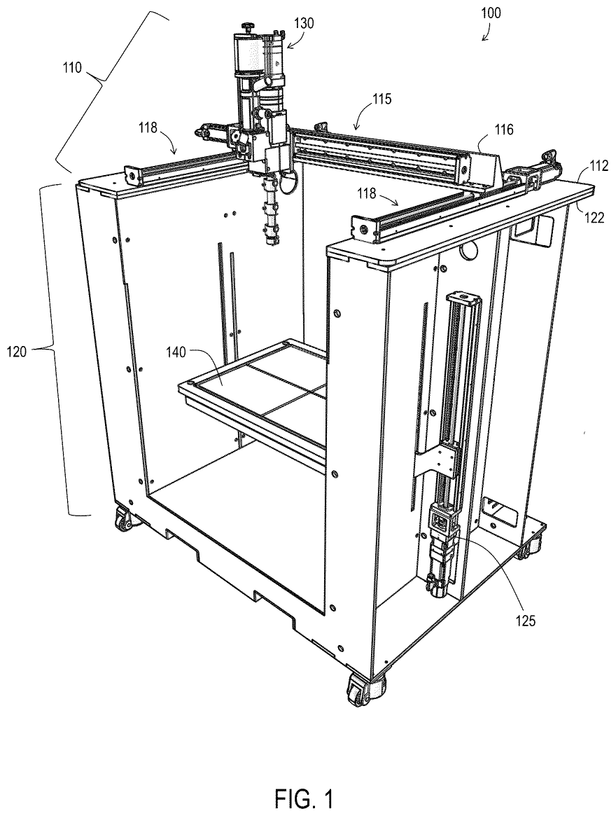

To provide a general context for the more detailed drawings that follow, FIG. 1 shows a configuration of one type of frame assembly 100 constructed in accordance with an example embodiment of the present teachings. FIG. 1 includes motion actuators and linear bearings that are mounted to an assembly of rigid frame components and oriented along several axes for effecting controlled movements between an extruder head 130 and a build surface 140, which are included in this view for explanatory purposes. Extruder head 130 may be regarded as a first payload to be moved by the subject motion control system. Build plate 140 (and any associated support structures and heating elements) may be regarded as a second payload to be moved by the subject motion control system.

Frame assembly 100 comprises an upper subassembly 110 and a lower subassembly 120 which are delineated by a parting plane between an upper interface plate 112 and a lower interface plate 122. Upper interface plate 112 serves as a mounting platform for various motion components of upper subassembly 110. Lower interface plate 122 is disposed horizontally atop numerous other structural members and presents a solid flat surface upon which upper subassembly 110 may rest and be rigidly attached once in place.

In some conventions for assigning motion axes, upper subassembly 110 may be called an ‘XY subassembly’ or ‘XY module’, whereas lower subassembly 120 may implement the remaining Z-axis motion function. Other arrangements and nomenclatures are possible. Lower subassembly 120 may also be referred to as a ‘base module.’

As will be explained in more detail, upper subassembly 110 comprises an X-axis linear actuator 115 mounted to a transverse gantry 116 which, in turn, is coupled to a pair of Y-axis linear actuators 118 that operate in tandem to translate the gantry towards or away from the front face of frame assembly 100. This set of components accomplishes movement along two orthogonal and generally horizontal axes, namely in a leftward or rightward direction corresponding to an X-axis coordinate value and either towards or away from the front of frame assembly 100 corresponding to a Y-axis coordinate value. Actuators 115, 118 collectively move a first payload, such as extruder head 130, along two orthogonal axes.

To implement controlled movement in a third axis that is normal to that of the X-axis and Y-axis actuator components just mentioned, lower subassembly 120 includes a pair of Z-axis linear actuators 125 (one of which is obscured in this view) which are coupled to raise or lower build surface 140 based on a Z-axis coordinate value. In at least one embodiment, Z-axis linear actuators 125 may act to move a second payload, such as a build plate.

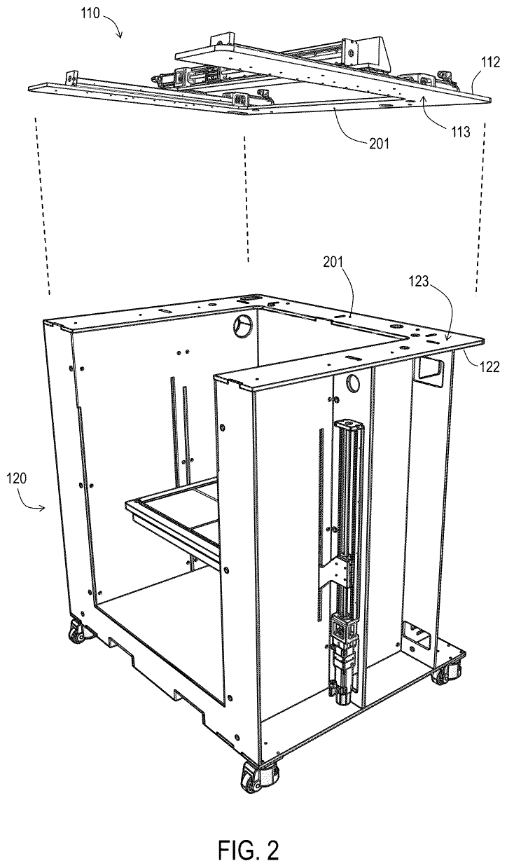

FIG. 2 shows upper subassembly 110 and lower subassembly 120 having been separated to reveal the mating surfaces, the underside of plate 112 is shown as upper orientational reference interface surface 113 (or simply reference interface surface 113) and the top face of plate 122, which shall be referred to as lower orientational reference interface surface 123 (or simply reference interface surface 123.) For clarity, extruder 130 has been excluded from this view. Plates 112 and 122 may be generally characterized as substantially flat members each having two broad or major faces facing outward and opposite one another. For example, plate 122 is depicted as cut from flat plate of and, disregarding the edges, exhibits an upward-facing major face, serving as reference interface surface 123, and a lower-facing major face. Other ‘plates’ or ‘panels’ described herein are generally taken to be substantially flat members and to distinctly have two broad faces on opposite sides of the respective member.

Both plate 112 and plate 122 may comprise a complementary pattern of holes, concavities or openings 201 that appear on surfaces 113,123 to allow for insertion of alignment pins, stops, fasteners or other features to assure mutual registration and rigid attachment between the upper and lower subassemblies as they come together to form the overall finished frame depicted in FIG. 1. For heavy frame construction, some holes in upper subassembly 110 may be threaded to allow for temporary attachment of hoisting hardware such as eye bolts.

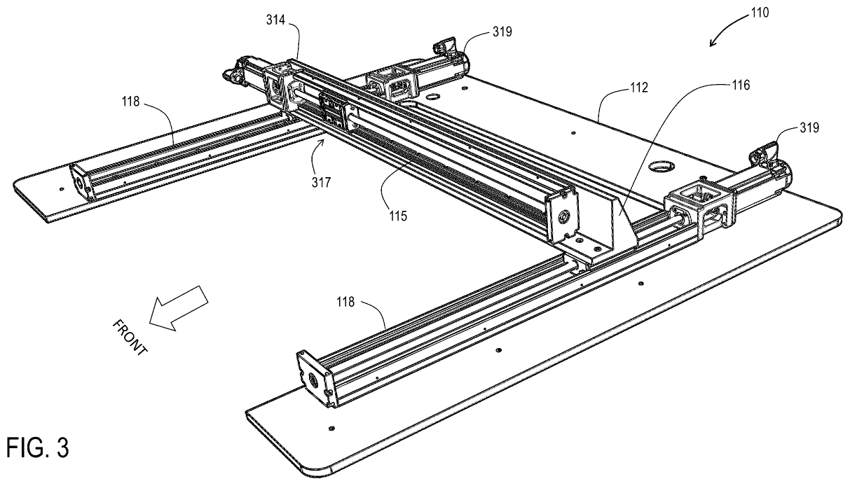

The views presented in FIGS. 3-6 afford a better understanding of a modular frame constructed according to the present teachings and at least one manner of assembling such a modular frame.

FIG. 3 is a pictorial showing motion components mounted on plate 112 as principal components of upper subassembly 110 (aside from a payload to be moved about, such as extruder 130 or a machining spindle motor.) Plate 112 is preferably cut by laser or abrasive jet into the U-shaped form as shown. Directly mounted to plate 112 are two Y-axis linear actuators 118 each driven by a servo motor 319. The axis of motion for each actuator 118 is manufactured to be parallel to its mounting surface within a fine tolerance and the attachment of the actuators 118 to a common surface of plate 112 permits precise and permanent parallel alignment of the actuators' axes. Consequently, the Y-axes motion is assured to be parallel to the top and bottom surfaces of plate 112 and therefore parallel to upper reference interface surface 113. A transverse beam or gantry 116, is supported at either by the moving carriages of actuators 118 such that driving actuators 118 in a synchronized manner can cause gantry 116 to move either towards or away from the front of the overall machine.

Gantry 116 is shown to carry linear actuator 115 to control motion along a direction that may be termed the ‘X axis.’ Driven by servo motor 314, linear actuator 115 provides a carriage surface 317 upon which implements, such as and extruder 130, may be mounted and drive signals sent to motor 314 may cause the attached implement to translate in an X direction, such as leftward or rightward relative to the overall machine.

The synchronization among of Y-axis actuators 118 and the correct mounting of gantry 16 can assure that the vector of movement caused by the X-axis actuator remains precisely perpendicular to the action of the Y-axis actuators. Furthermore, the elevation above the top of plate 112 at which gantry 116 is supported by Y-axis carriers is precisely known and constant. Therefore, the X-axis movement may be set to be orthogonal to the Y-axis movement. Once these relationships have been finely established among the XY module components, they need not be revisited when the XY module is eventually attached to a base unit or moved from one base unit to another. This attribute of the modular design offers distinct advantages in manufacturability and in facilitating field replacements and upgrades.

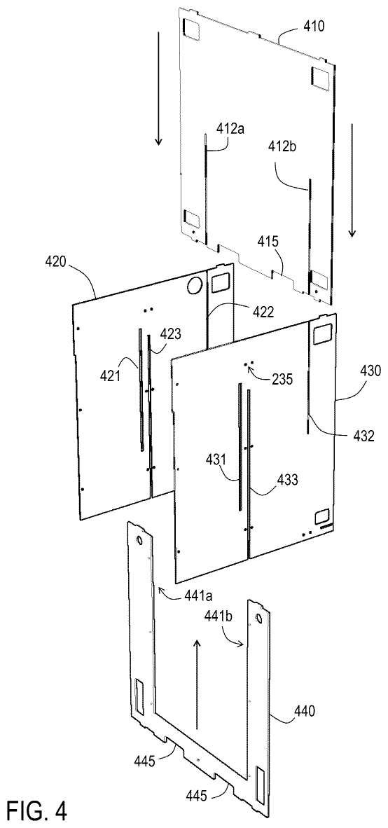

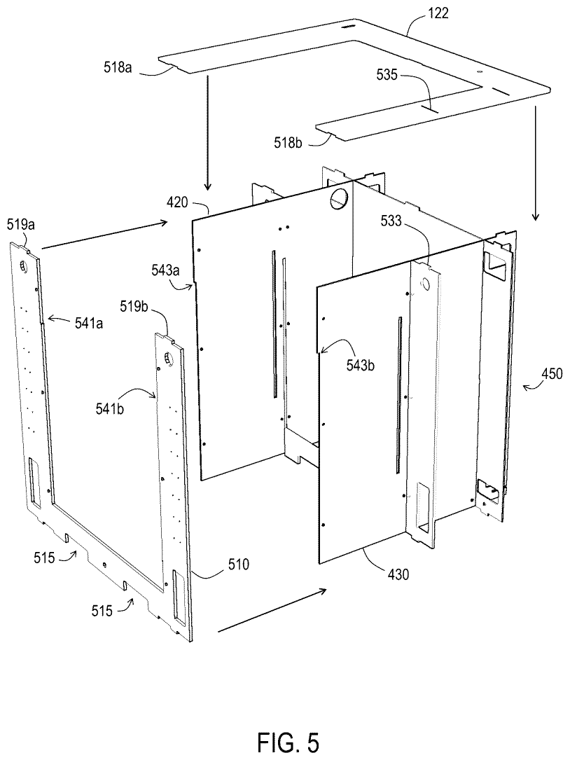

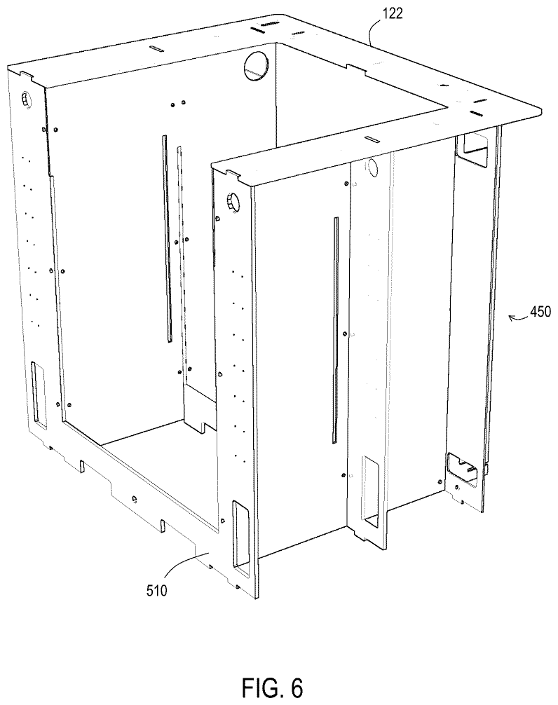

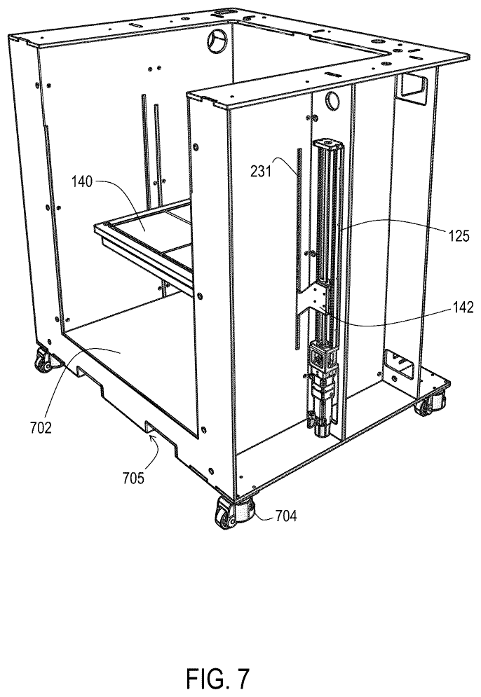

FIGS. 4-7 show how various panels and U-shaped members are brought together in forming a rigid lower subassembly. The sequence with which the components are introduced in this description is chosen primarily for clarity and does not limit the assembly sequence or part orientation that could be used in production. Although the components FIG. 4 are shown sliding into place vertically according to the orientation of the drawing, the actual orientation during the assembly may be with the parts laying on one side or inverted from what is shown, depending on a given manufacturers circumstances, fixturing and other constraints or preferences. This is true for FIGS. 5 and 6 as well, with the end result being an upright unit as depicted in FIG. 7.

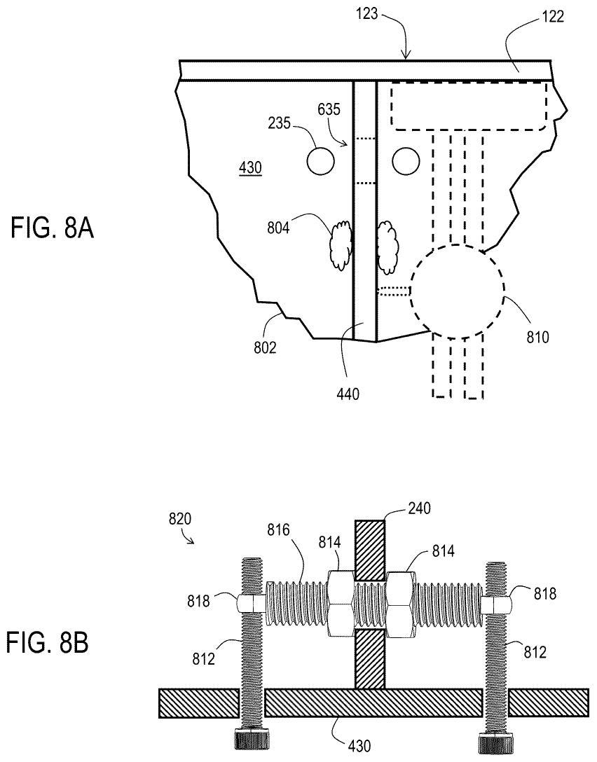

In FIG. 4, a left side panel 420 and a right side panel 430 are shown to comprise elongated slots 422 and 432 to receive a back panel 410 that has complementary slots 412a and 412b. For assembly of lower subassembly 120 as was shown in FIG. 2, back panel 410 is translated in the direction shown until it is fully seated within slots 422 and 432. Similarly, a U-shaped Z-axis yoke 440 is shown to engage side panels 420, 430 by sliding into slots 423 and 433, respectively. Z-axis yoke 440 is inserted until notches 441a, 441b come to rest against the ends of slots 423, 433. At some point in the assembly process, the panels brought together as shown in FIG. 4 are more permanently joined by welding, fastening, gluing or other means. Slots 421, 431 allow for passage of another member, introduced later, that will connect Z-axis actuators 125 to a build plate 140 supported within the assembled frame. One or more sets of paired holes 235 are shown on plate 430 to facilitate fine alignment of yoke 440 prior to permanent attachment to other members as will be explained in FIG. 8.

In at least one reduction to practice, panels 410, 420, 430 and yoke 440 were made by laser cutting steel plates that were 8-12 mm thickness, had the proportions shown and were roughly on the order of 1-2 meters in size along an outer edge. A pair of bottom edge notches 445 are shown to be cut away from yoke 440 to accommodate a forklift zone underneath the overall machine. A similar set of notches 415 are shown cut into back panel 410 for the same purpose.

The result of assembling the components shown in FIG. 4 is represented in FIG. 5 as an intermediate structure 450. Again, it should be noted that the assembly sequence shown in these figures is merely a simplified alternative to a single, comprehensive exploded diagram and should not be construed as being an only or preferred assembly sequence.

Adding to intermediate structure 450, a front panel 510 and lower interface plate 122 are moved into position as shown by the direction arrows and attached, such as by welding. For consistent placement of these components, numerous alignment features are included in the shaping of the panels. A step or notch 541a in front panel 510 comes to bear against a complementary notch 543a of left panel 420. Likewise, a notch 541b along an opposite edge of front panel 510 engages a complementary notch 543b in right panel 430. Upper interface plate 122 comprises notches 518a and 518b that receive tabs 519a and 519b formed at either end of the U-shaped front panel 510. As an even further measure for alignment and rigidity, lower interface plate 122 comprises several slots 535 that are placed to engage with protruding tabs 533 projecting upward from intermediate structure 450 due to tab cuts in panels and yoke components thereof. A pair of cutouts 515 are provided in front panel 510 for creating a forklift zone underneath the unit. These tabs, notches or slots form complementary interlocking shape features to achieve mutual engagement among members at specific positions or angles.

FIG. 6 shows the result of assembling the components that were presented in FIG. 5. Referenced parts have been previously introduced. In particular, FIG. 6 shows holes 635 through yoke 440 that come into position near holes 235 introduced earlier. As will be explained in FIG. 8B, these features work in conjunction with a clamping implement to facilitate aligning and permanent bonding of yoke 440 to other structural components.

FIG. 7 shows a more complete lower subassembly after the addition of a build chamber bottom plate 702, optional leveling casters 704, forklift sleeves 705, Z-axis linear actuator(s) 125, build plate support arms 142 and build plate 140. Though excluded or obscured from view, other minor frame members, hoses, cables, ducts, heaters, insulation, electronic enclosures and such may be attached to this assembly but are not essential to explaining the present inventive concepts. Build plate support arm 142 extends through slot 231 to couple Z-axis linear actuator 125 to build plate 140. Arm 142 allows for operation of a heated build plate 140 and heated enclosure formed by the walls of the base module while keeping the components of Z-axis linear actuator 125 isolated from elevated temperatures.

FIG. 8A is a close-up view of the junction between lower interface plate 122, right side panel 430 and Z-axis yoke 440, depicted as if observed straight on from the right side of the overall machine. Plate 122 and yoke 440 are observed on edge, whereas right side panel 430 is in the plane of the drawing and is indicated by breakaway lines 802.

During assembly of these components as depicted in FIGS. 4, 5 and 6, yoke 440 is set within slot 433 and precisely adjusted to be perpendicular to the underside of plate 122 (and therefore perpendicular to reference interface surface 123) before being permanently attached, such as by weld joints to the other two structures. To facilitate the fine adjustment before attachment, a pair of holes 235 are provided within right side panel to allow for the insertion of bolts, clamps, eccentric washers or other means that may be used to hold yoke 440 in exact alignment as it is welded in place. The location of a corresponding hole 635 through in yoke 440 is depicted as a hidden feature by a dotted line. The positioning of yoke 440 into a perpendicular location may be accomplished by static fixturing, laser interferometry, high-resolution scanning by a coordinate measurement machine (CMM) or by common measurement tools used by machinists. As an example of the latter, a sliding dial indicator apparatus 810 (shown in dotted outline) comprises a smooth shaft mounted in a magnetic base that may be attached to plate 122. Moving the dial indicator up and down along the shaft while its probe tip is in contact with a surface of yoke 440 provides a measurement of deviation from a perpendicular orientation between the two members. A similar procedure may be used where the opposite tip of yoke 440 meets the left side panel 420 and plate 122. Once yoke 440 is adjusted into a perpendicular orientation at both locations, the aforementioned temporary clamping implement may be fully tightened and then a series of balanced stitch welds 804 are made to permanently bond yoke 440, plate 122 and side panels 420, 430. The quality of alignment in the final assembly may be checked or monitored using the dial indicator apparatus 810. In practice, alignment has been achieved wherein the dial indicator shows no discernable deflection throughout its sliding range of motion.

FIG. 8B depicts one design of a temporary clamping implement 820 for drawing together, tightly clamping and providing fine alignment adjustment between yoke 440 and plate 122 just prior to permanent attachment via welded joints or the like. Multiple clamping implements 820 are preferably deployed to apply clamping at all points where holes 635 align with holes 235 during alignment. FIG. 8B generally shows an edge of yoke 440 meeting a surface of panel 430. (Plate 122 would therefore be parallel to the plane of this image.) A threaded bridge 816 is shown to pass through hole 635 in yoke 440 and fitted with one or two nuts 814 configured to bear against yoke 440 and press the latter leftward or rightward as the assembly is shown in this orientation. Each end 818 of bridge 816 comprises a threaded hole that runs transverse to the long axis of the bridge and accepts a bolt 812 that inserted through a corresponding hole 235 in panel 430. Each bolt 812 is preferably inserted from inside the enclosure and directed towards the periphery, meaning that the bolt heads face the inside of the build enclosure. Tightening of bolts 812 causes a clamping action of yoke 440 against panel 430 while turning nuts 814 apply lateral forces to move yoke 440 into alignment and to maintain the positioning as welding permanently then bonds the components. After welding, clamping implement 820 may be removed by loosening and removing bolts 812, then loosening nut 814 to allow bridge 816 to be withdrawn from hole 635.

Once yoke 440 has been aligned relative to reference interface surface 123, Z-axis linear actuators 125 may be mounted on either side, similar to what is shown in FIG. 7. Advantageously, the use of a single U-shaped yoke 440 formed from a single rigid metal plate that encircles the underside of the base unit ensures coplanarity among the two actuators (which may then work in tandem to lift or lower the build plate.) The actuators are preferably mounted on opposite extremities or forks of yoke 440. For the same reasons indicated in mounting the Y-axis actuators to plate 112, the parallel orientation of the paired Z-axis actuators is assured by using a common mounting surface on yoke 440. The Z-axis linear actuators may then be controlled to operate in unison to move a build plate towards or away from top plate 122.

Once the perpendicular relationship between yoke 440 and surface 123 is established and made permanent, then the base module effectively guarantees that the action of the Z-axis linear actuators will be perpendicular to the plane of the reference interface surface 123 regardless of what is placed atop the base unit. When mated to an XY module having its axes being mutually perpendicular and exactly parallel to reference interface surface 113, all three axes are certain to be mutually orthogonal. This modular division of managing the possible degrees of freedom in alignment of the motion axes leads to important practical advantages, both during manufacture and after deployment to an end user.

Although clamping implement 800 is shown in use at a specific junction in FIG. 8B, the same mechanism may be ubiquitously applied for alignment and joining many or all of the frame members depicted herein. Such points of application are evident by characteristics hole patterns near junctions among two members.

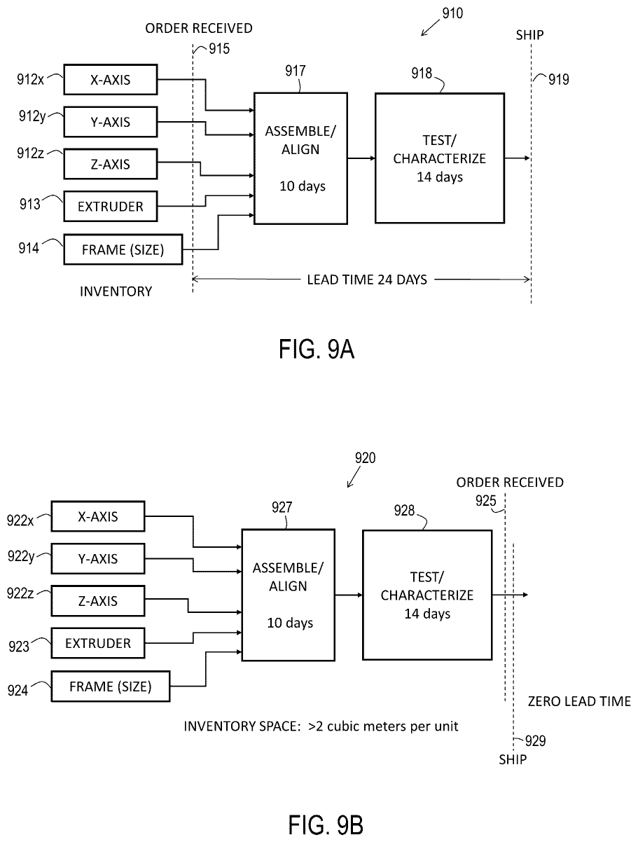

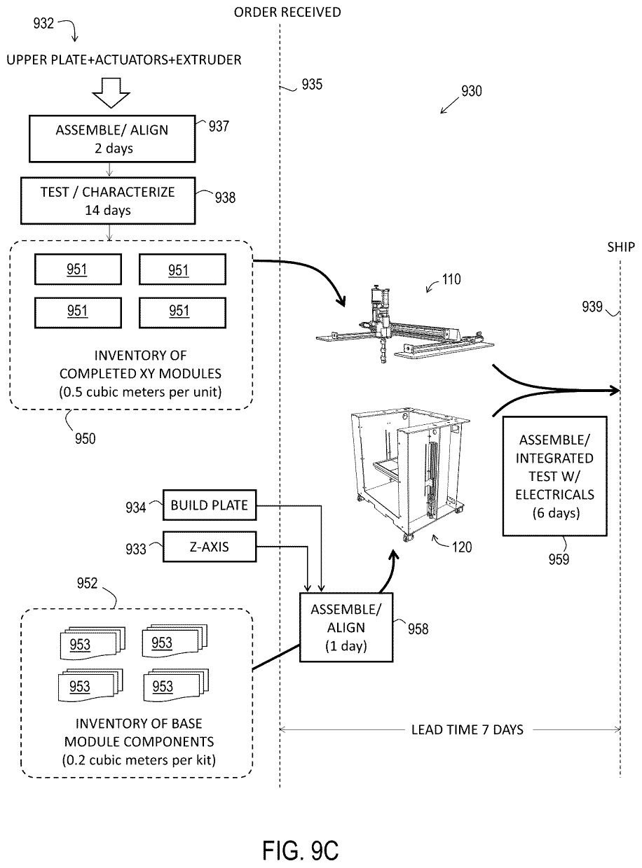

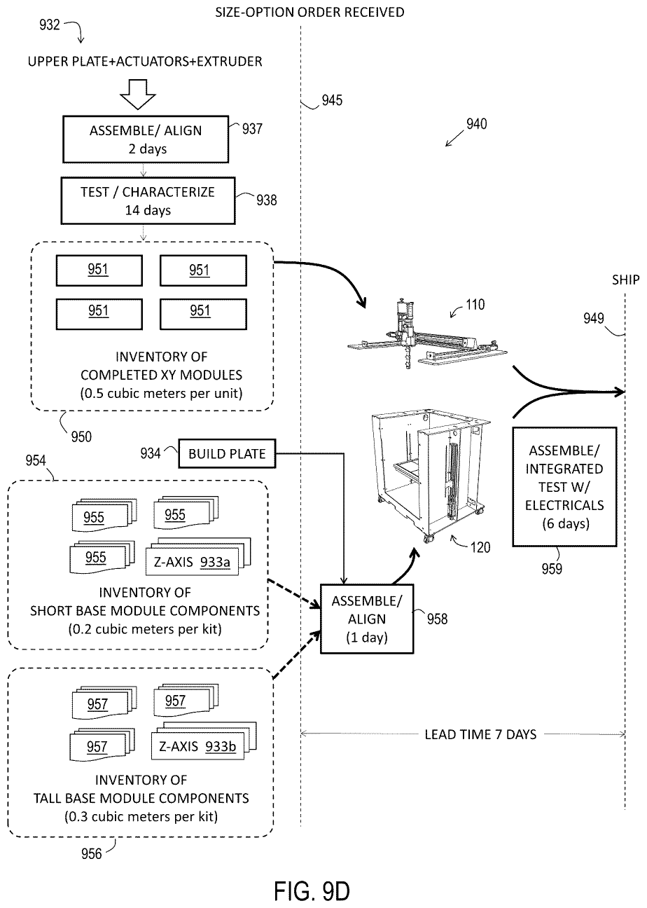

To best explain these advantages, FIGS. 9A-9D illustrate several scenarios for assembling and testing motion assemblies in the course of constructing and delivering finished additive manufacturing systems.

FIGS. 9A-9D are conceptual block diagrams depicting stages in manufacture of a unit (progressing left-to-right) and providing comparisons based on turnaround time and inventory space requirements.

FIG. 9A shows a typical process model 910 wherein each of the components for assembling a unit are maintained in inventory until an order for a unit is received. Upon receipt of an order for a unit, as indicated by dotted line 915, the requisite motor-driven actuators 912x, 912y, 912z and extruder 913 and frame 914 are assembled and aligned as shown by block 917. This activity may take 10 days, for example. After the complete assembly and alignment of said components, then any necessary operational tests, calibration and characterization (such as for extruder output parameters) are conducted as represented by block 918. This stage may require 14 days and involve temperature calibrations and running of test parts before the unit is shipped to fulfill the order as indicated by dotted line 919. The overall lead time after receipt of the order is 24 days, assuming all of the component parts are present in inventory and functioning properly after assembly.

FIG. 9B depicts an alternative process model 920 wherein one or more units are manufactured and tested prior to receiving an order. This approach for building an inventory of completed units is advantageous for eliminating manufacturing lead time but requires a manufacturer to set aside considerable space for units and invest substantial labor and hardware in anticipation of an order. This approach also complicates matters if a manufacturer wants to offer options in the construction of a unit, such as different frame sizes. Actuators 922x, 922y and 922z, plus extruder 923 and frame 924 are assembled and aligned as indicated by block 927. As with block 917 shown earlier, this effort may require approximately 10 days. This is followed by test, calibration and characterization of the assembled unit (including electronics that have not been explicitly shown thus far) shown in block 928 which may again require approximately 14 days. As indicated by dotted lines 925 and 929, the point at which an order is received (dotted line 925) may closely coincide with the time that the order is fulfilled (dotted line 929). In model 920, it is apparent that all of the assembly and test effort is generally performed before an order is received. A potential disadvantage is that, given the size of frame shown in earlier diagrams, each unit may occupy a volume on the order of two cubic meters. Storing completely built units may be burdensome for many manufacturers.

FIG. 9C shows a process model 930 for manufacturing units in a manner that is particularly enabled by the present teachings. Prior to receiving an order, one or more XY modules, corresponding to upper subassembly 110 shown earlier, may be assembled, aligned, tested and characterized. A complement of components 932 for creating an upper subassembly, including an upper plate 112, X-axis actuator 115, Y-axis linear actuators 118 and an extruder 130, are assembled (to resemble subassembly 110 in FIG. 1) and aligned as represented by block 937. Notably in accordance with the present teachings, the alignment entails ensuring that the motion directions for the X and Y axes are both parallel to upper plate 112 and are precisely orthogonal to one another. This stage of assembly may require 2 days or perhaps less.

An upper subassembly 110 that has been assembled with an extruder 130 (or some other implement for additive or subtractive processing) may then undergo operational testing and characterization as indicated by block 938. As an advantage of the present teachings, the full alignment test and characterization of an extruder-equipped upper subassembly may proceed even without being finally coupled to a particular base module with which the upper subassembly will eventually be shipped. A lower subassembly or the like may be used as a temporary test stand to provide a Z-axis movement and a build surface for doing test prints and other tests. These tasks may take, for example, 14 days. Once an upper subassembly has been assembled, aligned and characterized (as applicable), then a completely prepared subassembly 951 may be stored in inventory 950 where it stands ready to be coupled to a lower subassembly 120. The approximate storage volume occupied by each completed subassembly may be 0.5 cubic meters, for example.

Lower subassembly 120 may be assembled and aligned separately and asynchronously from any upper subassembly with which it may eventually be coupled to form a complete manufactured unit. In FIG. 9C, an inventory 952 may hold one or more lower frame kits 953 each comprising a set of lower subassembly frame components ready for assembly. Each lower frame kit 953 may comprise, for example, plate 122, panels 410, 420, 430, 450, yoke 440 and any other components needed to form the frame of a complete lower subassembly 120. Before assembly, each lower frame kit may occupy a relatively small volume such as 0.2 cubic meters. Upon receipt of an order as indicated by dotted line 935, a lower frame kit 953 may be obtained from inventory, assembled as depicted in FIGS. 4 through 6 and then coupled with inventoried Z-axis actuator(s) 933, build plate 934 and assorted other parts to form a lower subassembly 120. These actions are represented by block 958 and, based on actual experiences, may occur within a single day.

In response to an order for a completed unit, lower subassembly 120 is built from a lower frame kit 953 and then mated with a completed subassembly 110 that has already been tested and characterized. Upon attaching these subassemblies together, the orthogonal relationship between the motion axes is assured by virtue of implementing the present teachings as to each subassembly's alignment with respect to the reference interface surfaces at which they meet. Therefore, as a consequence of the measures taught herein, no further alignment needs to occur when the subassemblies are placed in contact.

A complete unit thus formed just needs to be combined and tested with the enclosure heaters and electronic control systems over a period of, for example, 6 days and then is ready for shipment (designated by dotted line 939). This last stage is represented by block 959. Process model 930 allows for proactive assembly and characterization of an upper subassembly before the time of an order while allowing the manufacture of corresponding lower subassembly to be delayed until an order is placed and allowing the parts of the lower subassembly to remain in a ‘collapsed’ kit form occupying less physical storage volume while in inventory. According to the present teachings, the more time-consuming alignment and characterization of the upper subassembly need not be delayed until the lower subassembly has been built. The turnaround time between order placement and shipment is reduced to approximately 7 days.

Another important advantage is explained in connection with FIG. 9D wherein process model 940 has many of the same elements as FIG. 9C but further provides for an inbound order to specify a choice from among different enclosure size options, such as different frame heights to enable a taller build envelope. While the preparation of upper subassembly 110 remains substantially the same as explained in connection with FIG. 9C, the assembly of lower subassembly 120 is differentiated based on the parameters of the order indicated by dotted line 945. Two different stocks of lower frame kits may be maintained. A first stockpile or inventory 954 may hold one or more frame kits 955 that are scaled to form a shorter style of lower subassembly frame whereas a second inventory 956 may hold one or more frame kits 957 for forming an alternative taller frame size.

The lower subassembly, which has a short assembly and alignment, allows for agility in choosing one or the other frame size option without impacting shipping lead times. Preparation of an upper subassembly, which requires significantly longer lead time, is decoupled from the frame size option decision and can be completed before the order is submitted. These aspects made possible by the present teachings support order flexibility while maintaining short lead times and just-in-time assembly of voluminous parts of the overall unit.

In FIG. 9D, the assembly of either a short unit or a tall unit based on an inbound product order involves selecting either a shorter frame kit 955 and mounting short Z-axis linear actuators 933a or a taller frame kit 957 and mounting a correspondingly longer version of Z-axis linear actuators 933b. Thereafter, process model 940 continues essentially as was described for process model 930.

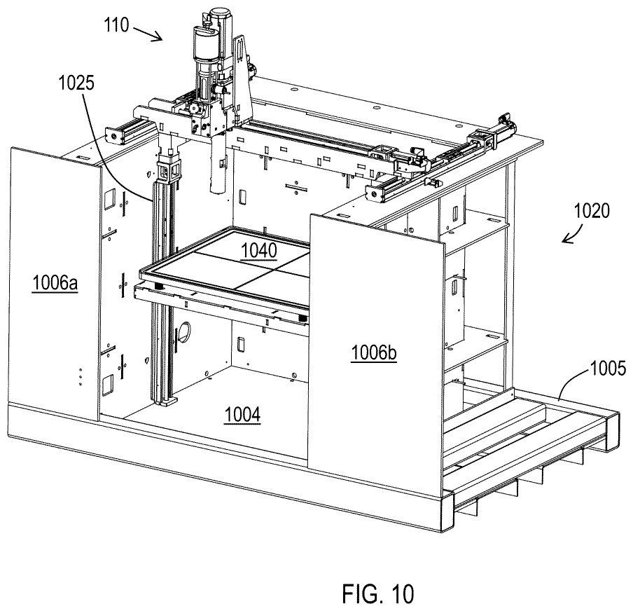

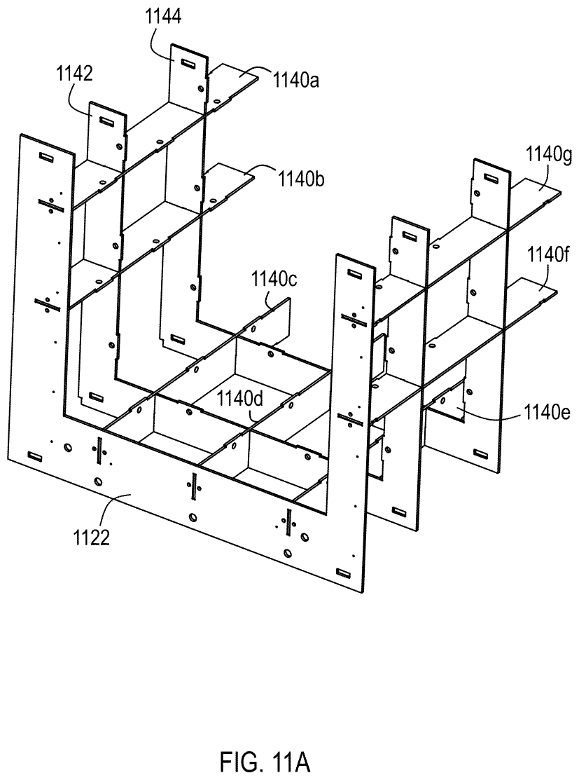

FIG. 10 depicts an alternative construction for a base module in which Z-axis actuators are disposed within an enclosed space formed by several wall plates. In this arrangement, Z-axis actuators 1025 (one being obscured in this view) are able to rigidly support a build plate 1040, in closer proximity than was shown in FIG. 1. This may subject the Z-axis actuator assemblies to elevated temperatures within the enclosed build chamber, but this may be acceptable in some implementations given that the power demands to drive the vertical axis are lower on average and that commercially available actuator assemblies are capable of sustained operation at the normal anticipated enclosure temperatures.

Comporting with the present teachings, alternatively constructed base portion 1020 offers similar advantages in ease of assembly, rigidity and assurance of alignment to a reference interface surface as was explained in connection with FIGS. 4-7.

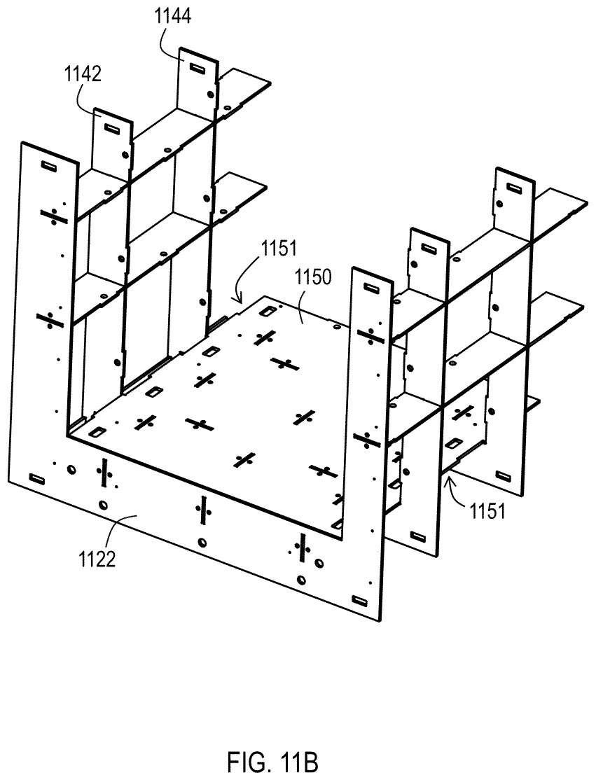

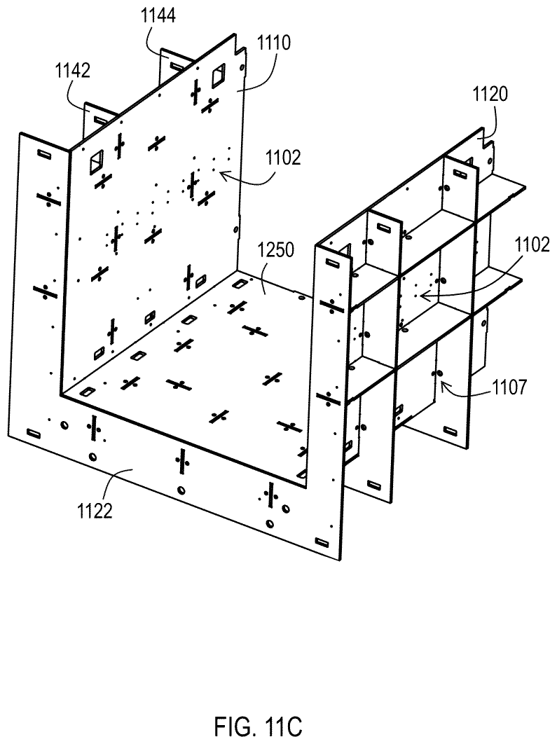

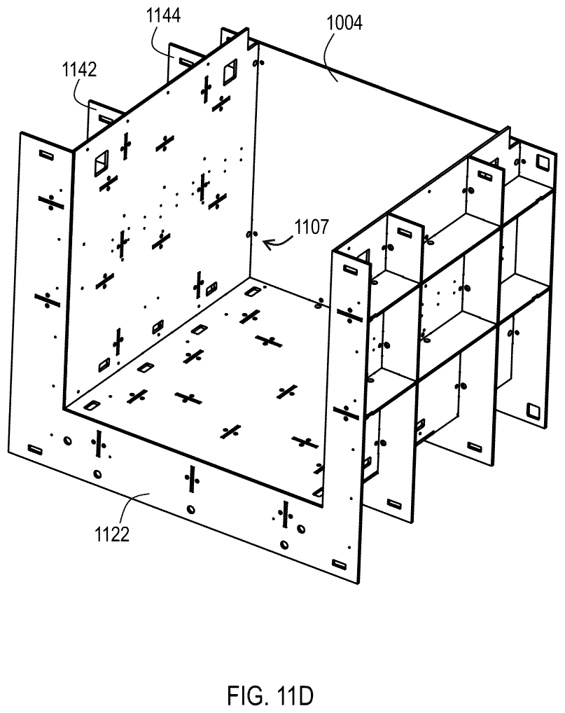

The interior-facing walls shown in FIG. 10 are surrounded and supported by a grid of interlocked structural members, which may be assembled and aligned, for example, as next described in FIGS. 11A-11D.

FIG. 11A shows a first stage in assembling base portion 1020 in accordance with an exemplary embodiment. For ease of assembly, it is useful to orient the components as if the base were laid upon its backside as shown. Top plate 1122, which will provide an equivalent to reference interface surface 123, along with a U-shaped rib plates 1142 and 1144, are placed in parallel and with all the concavity openings facing upward, as shown. Joining these first three U-shaped plates are a number of vertical slat members 1140a-g, positioned as shown. For ease of manufacture, these vertical slat members may be shaped identically. Although appearing to be horizontal in FIG. 11A, these vertical slat members will become vertical when the final assembly is set upright and plates 1122, 1142, 1144 will then assume a horizontal orientation. As with earlier descriptions herein, any of the ‘plates’, ‘panels’ or ‘slats’ depicted herein may be generally characterized as substantially flat in shape and having two distinct major or broader sides (versus narrow edges) that may be enumerated as first and second faces.

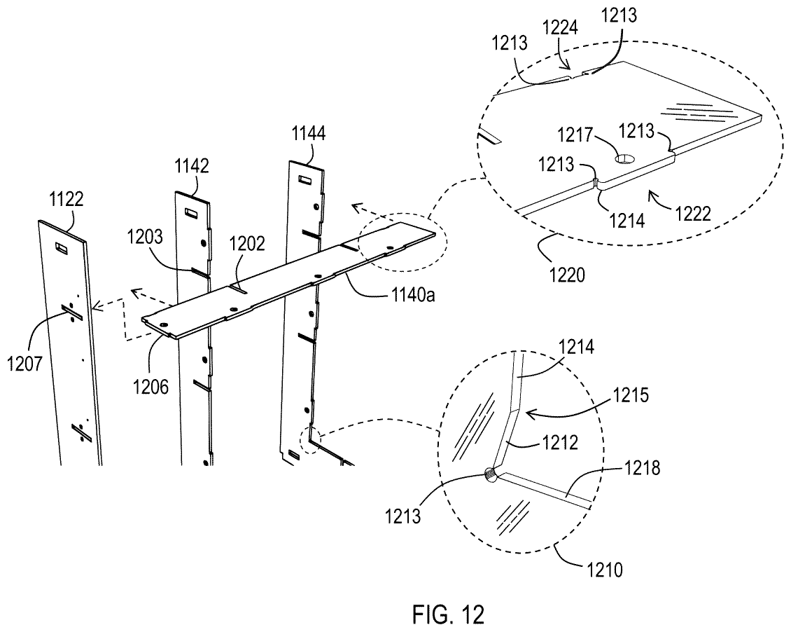

The manner of engagement between these components is best explained with brief reference to FIG. 12, which provides a partial exploded view for comparison to FIG. 11A. In FIG. 12, vertical slat member 1140a is shown to have at least one half-width slot 1202 while rib plate 1142 has a complementary slot 1203 positioned where rib plate 1142 and vertical slat member 1140a are to mutually interlock and eventually be fastened together such as by welding. As depicted by the dashed arrows, the components are engaged by aligning and translating member 1140a towards and into plates 1142 until fully interlocked engagement is achieved as shown in FIG. 11A. This is repeated for all other vertical slat members 1140b-g. It is considered preferable that each of the vertical slat members engage by motion in a direction outward from the center of the enclosure as opposed to being inserted from a more exterior location towards the center of the enclosure. In this preferred way, each slat member becomes confined and affirmatively forced against interior wall plates that are inserted later.

Engagement between slat member 1140a and top plate 1122 involves a tab 1206 being formed at end of member 1140a and being inserted into a corresponding slot 1207 in plate 1122. The actions of inserting all of the vertical slat members into the top plate and rib plates will result in the partial assembly shown in FIG. 11A.

FIG. 11B depicts the placing of a back plate 1150 within the partial assembly shown earlier. To facilitate the insertion of this back plate, it is found useful to provide a slightly angled cutout 1212 as shown in FIG. 12, inset view 1210, at all of the interior corners of rib plates 1142, 1144. This measure allows back plate 1150 to be lowered and tilted into final position without relaxing the close fit tolerances on all edges 1218, 1216 that will eventually bear against the back plate and side wall plates.

Inset view 1210 also shows a small-radius corner relief hole 1213 so that limitations on machining or cutting a perfect corner at an acute angle do not interfere with other parts that engage the corner aligning to the appropriate surfaces during assembly. This practice is recommended throughout the assembly and is also reflected at numerous locations in inset view 1220.

Inset view 1220 shows an outward tab 1222 protruding from an edge of slat member 1140a. Both inner corners of this shape include relief holes 1213. Furthermore, an outer corner 1214 of tab 1222 is shown to be radiused, mainly to facilitate assembly even though the final fit tolerances can remain very tight.

On the distant edge of member 1140a shown in inset view 1220, a notch 1224 has been formed for engaging other components later in the assembly. As with tab 1222, the interior corner features of notch 1224 are treated with relief holes 1213 and the outside corners are radiused. Interlocking notches 1202, 1203 may also have similarly treated inner and outer corners. A larger hole 1217 also shown in inset view 1220 serves a similar purpose as hole 635 in FIG. 8A in receiving a temporary clamping assembly 820.

Continuing with further assembly in FIG. 10C, after back plate 1150 has been inserted, side plates 1010 and 1020 are set in place as shown. The mating edges of the back plate and side plates have precisely formed complementary tabs that dovetail together, assuring fixed registration between the back plate and side plates. (See edge features 1151 in FIG. 11B.) After lowering the side plates into engagement as shown, the act of forcing the side plates outward to seat fully against rib plates 1142, 1144 preferably causes a centering and clamping action to occur against the back plate, using the slight convexity 1215, shown in inset view 1210, to act as a fulcrum. Each of the side plates 1010 and 1020 feature rows of holes 1102 for mounting Z-axis actuator assemblies.

At numerous points of joining shown in FIG. 10C an arrangement of holes 1107, comparable to holes 235 and 635 depicted in FIG. 8A, are provided so that a finely adjustable clamping mechanism 820, as shown in FIG. 8B, may be employed to rigidly draw all of the aforementioned components into firm contact. With precisely formed alignment features among all components, coupled with the finely adjustable clamping, precise orthogonality among base module components can be achieved. This is especially true as the precision cut side plates and back plate are brought into contact with top plate 1122. Top plate 1122 provides a reference interface surface for seating against an XY module and becomes precisely and permanently aligned with the mounting holes 1102 at which Z-axis actuators will be mounted.

A bottom plate 1004 may also be set into place as shown in FIG. 11D and welded or otherwise fastened. Bottom plate 1004 forms the bottom surface of the build enclosure, rigidifies the connection between the vertical slat members and the side and back plates. As shown in FIG. 10, bottom plate 1004 may eventually rest upon, or be attached to, a foundation assembly 1005 comprising struts and skids that support the entire framework and finished system. Foundation assembly 1005 may be designed to allow pallet movers and forklifts to move the finished system.

Alignment of the assembled components before final bonding may be verified by implements such as reference squares, dial indicator instruments (see apparatus 810 in FIG. 8A), metrology imaging cameras, laser interferometers, machinists' levels or static fixturing in a mass production environment. After satisfactory alignment is obtained and while at least some form of temporary clamping or steadying devices remain in place, short welds or other fastening techniques are applied to more permanently affix at least the key components shown in FIG. 11C.

Thereafter, base module 1020 is prepared to receive Z-axis actuator assemblies 1025 mounted using holes 1102. These mounting locations may provide for slight play, and therefore may enable further fine adjustment to align the Z-axis actuators to be orthogonal to reference interface surface of top plate 1102.

After components have been assembled and attached together, the entire assembly may be set upright, in the orientation shown in FIG. 10, and become permanently or removably joined to various other components, such as foundation assembly 1005 and front panels 1006a and 1006b.

The base module assembled thus far may also receive Z-axis actuator assemblies 1025, build plate 1040 and, to form a complete system, an XY module 110. Other components, such as an electronics bay, enclosure heating elements, ducting, exterior panels, insulation, hoses, cables, shrouds, cable guides, extruder coolant pumps and the like may be attached to form a complete system but are excluded from FIG. 10 so as not to obscure the main features being explained.

Adopting a terminology wherein XY module 110 is said to comprise a first flat plate, such as upper interface plate 112, having first and second broad faces, and base module 1020 comprises a second flat plate, namely top plate 1020 (analogous to lower interface plate 122 in FIG. 6), which has third and fourth broad faces, either of the side plates may then be considered as a third flat member having a fifth face and being affixed to the fourth face of the second plate in a position the fifth face being perpendicular to the fourth face. A controlled motion actuator, such as a Z-axis actuator assembly 1025, may be mounted to the third rigid plate and coupled to a build plate such that controlled motion implemented by the actuator moves the build plate along a direction vector that is perpendicular to the third face. Thus, when an XY module is fastened onto top plate 1020, the motion of the build plate caused by the Z-axis actuators is in a direction precisely orthogonal to the planes of top plate 1020, of a plate 112 (when attached) and of the motion of X and Y actuators of the XY module.

As explained in conjunction with FIG. 9C, the style of base module assembly depicted in FIGS. 11A-11D likewise offers advantages in manufacturing agility and decoupling from XY module production and test. Field replacement and interchangeability of XY modules are facilitated as well.

In the preceding description, various principles and exemplary embodiments have been described with reference to the accompanying drawings. It will be evident, however, that various modifications and changes may be made thereto, and additional embodiments may be implemented, without departing from the scope of the invention as set forth in the claims that follow. The description and drawings are, therefore, to be regarded in an illustrative rather than a restrictive sense.

What is claimed is:

1. A modular multiple-axis motion control system comprising:
a first subassembly comprising:
a substantially flat first plate having a first face and an oppositely facing second face as major faces of the first plate;
a plurality of controlled motion actuators mounted to the first face and configured to effect controlled motion of a first payload along at least two direction vectors that are orthogonal to one another and are each parallel to the second face; and
a second subassembly comprising:
a substantially flat second plate having a third face and an oppositely facing fourth face as major faces of the second plate;
at least one substantially flat third plate having a fifth major face and being affixed to the fourth face of the second plate in a position with the fifth major face being perpendicular to the fourth face;
at least one second controlled motion actuator mounted to the third plate and coupled to a second payload, wherein the second controlled motion actuator is configured to effect controlled motion of the second payload along a direction vector that is perpendicular to the third face;
wherein the first subassembly and second subassembly are joined by placing the second face against the third face and attaching the first subassembly to the second subassembly.

2. The modular multiple-axis motion control system of claim 1 wherein the third plate is formed with a concave opening that spans the breadth of a build space within which the first and second payloads are moved by the motion control system and wherein a first instance of the second controlled motion actuator is disposed along one extremity of the third plate and a second instance of the second controlled motion actuator is disposed along an opposite extremity of the third plate, the first and second instances of the second controlled motion actuator being oriented to operate in unison to move the second payload.

3. The modular multiple-axis motion control system of claim 2 wherein the motion control system is an extrusion deposition additive manufacturing system, the first payload is a material extruder and the second payload is a build plate upon which materials are deposited by extrusion.

4. A modular base subassembly for a motion control system comprising multiple motion actuators apportioned among separate, joinable subassemblies, the base subassembly comprising:
at least one top plate member providing a first orientational reference interface surface for contacting a second orientational reference interface surface of an upper subassembly when the upper subassembly becomes attached to the base subassembly;
at least one first side plate member, disposed perpendicularly to the top plate member, to which at least one linear actuator is attached for moving a payload towards and away from the top plate member; and
at least one back plate member, disposed perpendicularly to both the top plate member and to the first side plate member;
wherein the top plate member, first side plate member and back plate member comprise complementary interlocking shape features to mutually engage one another at right angles; and
wherein at least one of the top plate member, side plate member and back plate member further comprise hole patterns allowing insertion of one or more adjustable clamping mechanisms to draw the members into alignment such that a motion axis of the linear actuator is maintained normal to the first orientational reference interface surface.

5. The modular base subassembly of claim 4 further comprising:
a second side plate member contacting both the top plate member and the back plate member at right angles and comprising hole patterns allowing insertion of one or more of the adjustable clamping mechanisms.

6. The modular base subassembly of claim 5 further comprising:
at least one rib plate member disposed parallel to the top plate member and contacting at least two of the first side plate member, second side plate member and the back plate member;
wherein the rib plate member comprises at least one hole pattern allowing insertion of the adjustable clamping mechanism.

7. The modular base subassembly of claim 6 further comprising:
at least one slat member disposed perpendicularly to the rib plate member and having at least one first interlocking notch to engage with a second interlocking notch formed in the rib plate member.

8. A method for manufacturing a modular frame for a multiple-axis motion control system, the method comprising:
obtaining a first subassembly having a first orientational reference interface surface and at least one first motion actuator for moving a first payload relative to the first orientational reference interface surface;
obtaining a second subassembly having a second orientational reference surface and at least one second motion actuator for moving the second payload relative to the second orientational reference interface surface;
joining, by bringing the first orientational reference interface surface into contact with the second orientational reference interface surface, at least the first subassembly and the second subassembly to form a composite frame of the motion control system, whereupon motion produced by the first and second motion actuators results in relative motion between the first payload and the second payload; and
performing an alignment of either, or both of, the first motion actuator relative to the first orientational reference interface surface and the second motion actuator relative to the second orientational reference interface surface prior to the joining.
